(19) United States
(12) Patent Application Publication
(10) Pub. No.: US 2002/0178106 A1
(43) Pub. Date: Nov. 28, 2002

(54) Self-aggregating information exchange

(76) Inventor: Rolf Dobeli, Aventura, FL (US)

Correspondence Address: Bradford E. Kile, Kile Goekjian Lerner & Reed, PLLC, The Evening Star Bldg. Ste.800, 1101 Pennsylvania Ave. NW, Washington, DC, 20004, US

(21) Appl. No.: 09/862,709

(22) Filed: May 23, 2001

(51) Int. Cl. G06F 17/60

(52) U.S. Cl. 705/37

(57) ABSTRACT

A self-aggregating information exchange protocol provides for a website to receive and supply information. A website receives a first question from a first user and a proposed answer from a bidder. Once the website owner receives an offer of acceptance from the first user and payment thereof, the website owner then causes the website to receive a full answer to the question from the bidder. The website then provides the full answer to the first user and pays compensation to the bidder. If a second question is supplied to the website from a second user and upon recognizing that the second question is essentially similar to the first question, the second user is provided with an offer to provide the same or similar answer. Once the second user accepts the offer, the website owner causes the website to deliver the answer to the second user in exchange for compensation from the second user to the website owner and the bidder.

### FIELD OF THE INVENTION

The invention relates generally to a method and system for the exchange of information via a question and answer format in an electronic communication arena.

### BACKGROUND OF THE INVENTION

It is known to provide a platform for the exchange of information via an electronic communication arena. One such example for the exchange of information is found at an Internet website called “itsquare.com”. At this Internet website, persons who wish to have computer programming projects completed, can post the details of the project. Interested computer programmers may than post bids for completing the project, which can be arranged through intermediation by the owner of the “itsquare.com” website.

### SUMMARY OF THE INVENTION

It is an object of the present invention to provide an Internet website where users post questions and bidders respond to the questions by proposing an answer for a fee.

Briefly, the present invention provides an Internet website where user questions, such as in the field of business, can be posted. A typical question might be “How do I plan the introduction of pharmaceutical products into the Indonesia market”? In response to these questions, offers for answering the questions may also be posted on the website. An answer contains the price, which the person proposing to answer the question demands, as well as the qualifications of the proposed answerer. For example, that person may state other similar projects, which he or she previously developed, scientific publications, and the like. If an offer for providing an answer is accepted, the answer is provided to the user by means of the website. The website need not necessarily earn any immediate compensation for this service. However, according to the invention, it is essential that the answer, which is ultimately provided, remains available on the website (although password protected) and, as such, becomes the property of the owner of the website. Therefore, according to the invention, if at a later time the same or similar question is posted on the website by a third person, the owner of the website is able to offer the same answer at a price that the owner of the website may determine. In accordance with the prearranged terms determined with the author of the original answer, the author may, in one embodiment, receive a fee, such as a percentage royalty, for the second and subsequent provision of the same answer in response to user questions.

Other objects, features, and advantages of the present invention will become apparent when considered in conjunction with the accompanying drawings. The invention, though, is pointed out with particularity by the appended claims.

### BRIEF DESCRIPTION OF THE DRAWINGS

FIG. 1 illustrates a diagrammatic representation of the interactions between participants in accordance with the preferred embodiment of the present invention.

FIG. 2 is a flow chart of the interactions between participants in accordance with the preferred embodiment of the present invention.

### DETAILED DESCRIPTION OF THE PREFERRED EMBODIMENTS

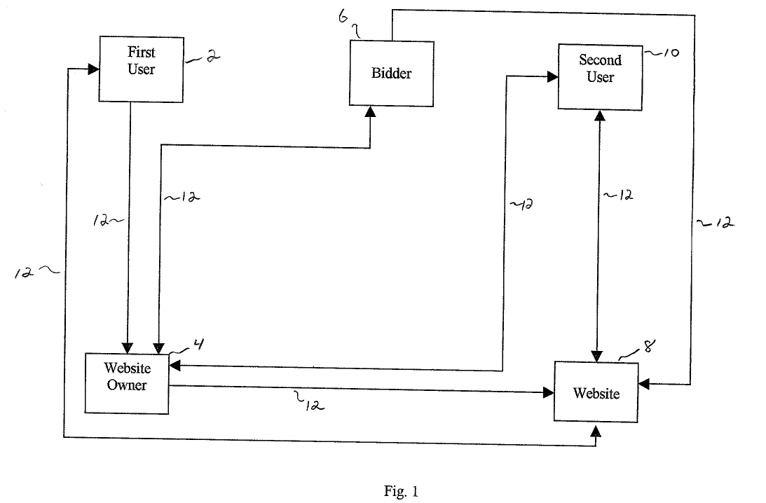

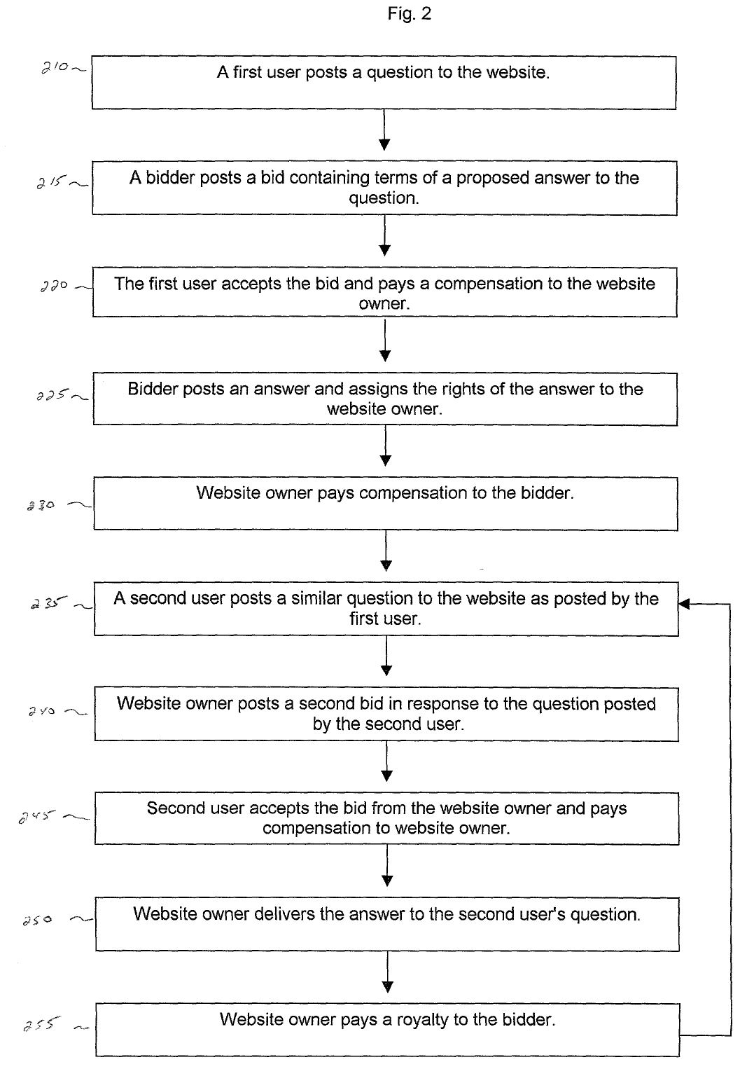

Referring to FIG. 1, a diagrammatic illustration shows how users can post questions on an Internet website and receive answers therefrom for a fee. Specifically, a first user 2 connects to website 8 via a public network, such as the Internet 12. Other persons can also connect to the same website 8 via the same public network 12. Such persons include a second user 10 and a bidder 6. The bidder 6 not only views questions posted to the website 8, but is also allowed to post a detailed response to the questions posted by users. The website 8 is under the control of a website owner 4, and as such, the website 8 archives the received answers, bids, passwords, etc. The website owner 4 receives fees from the users based upon the information the users receive from the website 8. The operation of a preferred embodiment of the invention will be described with reference to FIG. 2.

FIG. 2 shows a flowchart indicating the operational steps of the preferred embodiment. A first user 1 may post a question to the website 8 via the public network, step 210. Once a question is posted, other persons known as bidders, can respond to the question of step 210. A bidder 3, responding to the question, posts a bid containing the terms of a proposed answer to the question along with a suggested fee for providing a complete answer, step 215. Once the first user 1 accepts the bid for the question, the first user agrees to pay compensation to the website owner 4, step 220. Upon payment to the website owner 4, the bidder 6 posts the full answer and assigns the rights of the answer to the website owner 4, step 225. The full answer is stored in an archival system. The website owner 4 then pays the bidder 6, step 230. Subsequently, if a second user 10 posts the same (or essentially the same) question as the first user 2, step 235, the process follows similar steps as with the first user 2, but with some differences. Furthermore, the process for recognizing a previous question can be done by any means known in the art, including natural language processing, automated word matching, or partially or wholly by human intervention. The website owner 4 is now in a position to post a bid containing the terms for which the website owner 4 will answer the similar question, step 240. If the second user 10 accepts the bid from the website owner 4, then the second user 10 will pay compensation to the website owner 4, step 245. Once the website owner 4 receives payment from the second user 10, the website owner 4 deliver the answer, from the archival system, to the second user 10 via the website 8, step 250. Optionally, the website owner 4 may also pay royalty to the bidder 6 as compensation for having provided the answer to the second user 10, step 255. The process repeats itself for each new question posted by a new user and for similar questions posted by subsequent second users.

Therefore, according to a preferred embodiment of the invention, the ability of website owner 4 of the website 8 to answer questions is enhanced by the described self-aggregating manner of operation of the information exchange.

It is to be understood that the provided illustrative examples are by no means an exhaustive compilation of the many possible uses for the invention. The invention may be used in various environments requiring the exchange of information, in such fields as medicine, computer programming, education, business, etc.

Additional advantages and modifications will be readily apparent to those skilled in the art. The invention in its broader aspects is therefore not limited to the specific details, representative devices, and illustrative examples shown and described. Accordingly, departures may be made from such details without departing from the spirit or the scope of the Applicant's general inventive concept. The invention is defined in the following claims.

I claim:

1. In an online information exchange, a method of aggregating information comprising the steps of:
receiving and posting a first question from a first user;
receiving a bid from a bidder containing the terms of a proposed answer to said question;
receiving acceptance of said bid from said bidder;
receiving said answer from said bidder and making said answer available to said first user in consideration of said bidder's provision of rights in said answer to a website owner;
archiving said received answer in an archival file;
receiving a second question from a second user and recognizing that said second question is essentially similar to said first question;
accessing said archival file and transmitting to said second user an offer to provide said first answer;
receiving acceptance of said offer from said second user; and
delivering said answer to said second user in exchange for consideration flowing from said second user to said website owner and said bidder.

2. An online information exchange comprising:
a website, under the control of a website owner, for receiving and posting a first question from a first user, said website also receiving a bid from a bidder containing the terms of a proposed answer to said question;
said website receiving acceptance of said bid from said first user, said website further receives an answer from said bidder and makes it available to said first user in consideration of said bidder's provision of rights to said website owner;
an archival file system for storing said received answer;
said website receives a second question from a second user and recognizing that said second question is essentially similar to said first question;
said website owner transmits to said second user an offer to provide said first answer and awaits acceptance of said offer from said second user; and wherein, said website owner causes said website to access said archival file and deliver said answer to said second user in exchange for consideration flowing from said second user to said website owner and said bidder.

3. A self-aggregating information exchange protocol, said protocol comprises:
providing a website for receiving and supplying information; and
providing a website owner for controlling the website, wherein said website receives a first question from a first user and a proposed answer from a bidder, once the website owner receives an offer of acceptance from said first user and payment thereof, said website owner then causes said website to receive a full answer to the said question from said bidder and stores said received answer in an archival file.

4. The self-aggregating information exchange protocol as claimed in claim 3 wherein said protocol further comprises:
causing said web site to access said archival file and provide said full answer to said first user and pay compensation to said bidder.

5. The self-aggregating information exchange protocol as claimed in claim 4 wherein said protocol further comprises:
providing a second question to said website from a second user and recognizing that said second question is essentially similar to said first question; and
transmitting to said second user an offer to provide said first answer and await acceptance of said offer from said second user, wherein said website owner causes said website to deliver said answer from said archival file to said second user in exchange for compensation from said second user to said website owner and said bidder.
